(19) United States
(12) Patent Application Publication
(10) Pub. No.: US 2019/0179548 A1
(43) Pub. Date: Jun. 13, 2019

(54) MEMORY SYSTEM AND OPERATING METHOD THEREOF

(71) Applicant: SK hynix Inc., Gyeonggi-do (KR)

(72) Inventor: Jong-Min LEE, Seoul (KR)

(21) Appl. No.: 16/041,298

(22) Filed: Jul. 20, 2018

(30) Foreign Application Priority Data
Dec. 12, 2017 (KR) 10-2017-0170088

(51) Int. Cl. G06F 3/06

(52) U.S. Cl. CPC G06F 3/0631; G06F 3/0673; G06F 3/0659; G06F 3/0604

(57) ABSTRACT

A memory system may include: a memory device including a plurality of pages in which data are stored and a plurality of memory blocks in which the pages are included; and a controller suitable for performing command operations corresponding to a plurality of commands received from a host, in the memory blocks, checking parameters for the memory blocks corresponding to performing the command operations, and allocating second memory blocks as first target memory blocks based on the parameters after skipping the first memory blocks among the memory blocks.

### CROSS-REFERENCE TO RELATED APPLICATION

This application claims priority under 35 U.S.C. § 119 to Korean Patent Application No. 10-2017-0170088 filed on Dec. 12, 2017, which is incorporated herein by reference in its entirety.

### BACKGROUND

### 1. Field

Exemplary embodiments relate to a memory system, and more particularly, to a memory system which processes data with respect to a memory device, and an operating method thereof.

### 2. Discussion of the Related Art

The computer environment paradigm has moved to ubiquitous computing systems that can be used anytime and anywhere. The use of portable electronic devices such as mobile phones, digital cameras, and notebook computers has rapidly increased. These portable electronic devices generally use a memory system having one or more memory devices for storing data. A memory system may be used as a main or an auxiliary storage device of a portable electronic device.

Memory systems may provide excellent stability, durability, high information access speed, and low power consumption because they have no moving parts (e.g., a mechanical arm with a read/write head) as compared with a hard disk device. Examples of memory systems having such advantages include universal serial bus (USB) memory devices, memory cards having various interfaces, and solid state drives (SSD).

### SUMMARY

Various embodiments are directed to a memory system and an operating method thereof, capable of minimizing complexity and performance deterioration of a memory system and maximizing use efficiency of a memory device, thereby quickly and stably processing data with respect to the memory device.

In an embodiment, a memory system may include: a memory device including a plurality of pages in which data are stored and a plurality of memory blocks in which the pages are included; and a controller suitable for performing command operations corresponding to a plurality of commands received from a host, in the memory blocks, checking parameters for the memory blocks corresponding to performing the command operations, and allocating second memory blocks as first target memory blocks based on the parameters after skipping the first memory blocks among the memory blocks.

The controller may sequentially allocate the second memory blocks among the memory blocks, as the first target memory blocks, through a round robin scheduling scheme.

The controller may allocate the second memory blocks as the first target memory blocks for performing command operations, and may allocate the first memory blocks as second target memory blocks for performing a swap operation.

Parameters for the first memory blocks may exceed a first threshold value, and parameters for the second memory blocks may be equal to or less than the first threshold value.

The controller may determine the first threshold value corresponding to the parameters, and calculates a threshold offset corresponding to the number of the first memory blocks and the parameters of the first memory blocks.

The controller may dynamically adjusts the first threshold value corresponding to the threshold offset, and the number of the first memory blocks and the number of the second memory blocks among the memory blocks may be adjusted depending on the first threshold value which is adjusted dynamically.

The controller may count the number of the first memory blocks, and may calculates the threshold offset when the number of the first memory blocks exceeds a second threshold value.

The controller may determine the second threshold value corresponding to the number of the second memory blocks and the number of the second target memory blocks.

The controller may determine, as the first threshold value, at least one among an average value, a calculation value of a maximum value and a minimum value and a metric calculation value for the parameters, and may determine, as the second threshold value, at least one among an average value, a minimum value and a metric calculation value for the number of the second memory blocks and the number of the second target memory blocks, the controller may calculate, as the threshold offset, at least one among an offset between an average value for the first memory blocks and the first threshold value, an offset between a calculation value of a maximum value, a minimum value and the first threshold value and an offset between a metric calculation value and the first threshold value.

The controller may adjust a triggering rate of the swap operation corresponding to the number of the first memory blocks.

In an embodiment, a method for operating a memory system, may include: receiving a plurality of commands from a host, for a memory device including a plurality of pages in which data are stored and a plurality of memory blocks in which the pages are included; performing command operations corresponding to the commands, in the memory blocks; checking parameters for the memory blocks corresponding to performing the command operations; and allocating second memory blocks as first target memory blocks based on the parameters after skipping first memory blocks among the memory blocks.

The allocating may sequentially allocate the second memory blocks among the memory blocks, as the first target memory blocks, through a round robin scheduling scheme.

The allocating may include: allocating the second memory blocks as the first target memory blocks for performing command operations; and allocating the first memory blocks as second target memory blocks for performing a swap operation.

Parameters for the first memory blocks may exceed a first threshold value, and parameters for the second memory blocks may be equal to or less than the first threshold value.

The method may further include: determining the first threshold value corresponding to the parameters; determining a second threshold value corresponding to the number of the second memory blocks and the number of the second target memory blocks; calculating a threshold offset corresponding to the number of the first memory blocks and parameters of the first memory blocks; dynamically adjusting the first threshold value corresponding to the threshold offset; and adjusting a triggering rate of the swap operation corresponding to the number of the first memory blocks.

The number of the first memory blocks and the number of the second memory blocks among the memory blocks may be adjusted depending on the first threshold value which is adjusted dynamically.

The calculating may include: counting the number of the first memory blocks; and calculating the threshold offset when the number of the first memory blocks exceeds the second threshold value.

The calculating may calculate, as the threshold offset, at least one among an offset between an average value for the first memory blocks and the first threshold value, an offset between a calculation value of a maximum value, a minimum value and the first threshold value and an offset between a metric calculation value and the first threshold value.

The determining of the first threshold value may determine, as the first threshold value, at least one among an average value, a calculation value of a maximum value, a minimum value and a metric calculation value for the parameters, and the determining of the second threshold value may determine, as the second threshold value, at least one among an average value, a minimum value and a metric calculation value for the number of the second memory blocks and the number of the second target memory blocks.

In an embodiment, a memory system may include: a memory device including a plurality of memory blocks, each including a plurality of pages; and a controller suitable for allocating at least one memory block to a first operation in response to a command delivered from a host, checking parameters for allocated memory block, and re-allocating the allocated memory block based on the parameters to a second operation, the first operation may be performed in response to the command, while the second operation is a background operation.

### BRIEF DESCRIPTION OF THE DRAWINGS

These and other features and advantages of the present invention will become apparent to those skilled in the art to which the present invention pertains from the following detailed description in reference to the accompanying drawings, wherein:

FIG. 1 is a block diagram illustrating a data processing system including a memory system in accordance with an embodiment of the present invention;

FIG. 2 is a schematic diagram illustrating an exemplary configuration of a memory device employed in the memory system shown in FIG. 1;

FIG. 3 is a circuit diagram illustrating an exemplary configuration of a memory cell array of a memory block in the memory device shown in FIG. 2;

FIG. 4 is a schematic diagram illustrating an exemplary three-dimensional structure of the memory device shown in FIG. 2;

FIGS. 5 to 7 are examples of schematic diagrams for a data processing operation in which a plurality of command operations are performed in a memory system in accordance with an embodiment;

FIG. 8 is an example of a schematic flow chart of an operation process for processing data in a memory system in accordance with an embodiment;

FIGS. 9 to 17 are diagrams schematically illustrating application examples of the data processing system shown in FIG. 1 in accordance with various embodiments of the present invention.

### DETAILED DESCRIPTION

Various embodiments of the present invention are described below in more detail with reference to the accompanying drawings. However, the present invention may be embodied in different other embodiments, forms and variations thereof and should not be construed as being limited to the embodiments set forth herein. Rather, the described embodiments are provided so that this disclosure will be thorough and complete, and will fully convey the present invention to those skilled in the art to which this invention pertains. Throughout the disclosure, like reference numerals refer to like parts throughout the various figures and embodiments of the present invention.

It will be understood that, although the terms “first”, “second”, “third”, and so on may be used herein to describe various elements, these elements are not limited by these terms. These terms are used is to distinguish one element from another element. Thus, a first element described below could also be termed as a second or third element without departing from the spirit and scope of the present invention.

The drawings are not necessarily to scale and, in some instances, proportions may have been exaggerated in order to clearly illustrate features of the embodiments.

It will be further understood that when an element is referred to as being “connected to”, or “coupled to” another element, it may be directly on, connected to, or coupled to the other element, or one or more intervening elements may be present. In addition, it will also be understood that when an element is referred to as being “between” two elements, it may be the only element between the two elements, or one or more intervening elements may also be present.

The terminology used herein is for the purpose of describing particular embodiments only and is not intended to be limiting of the present invention. As used herein, singular forms are intended to include the plural forms as well, unless the context clearly indicates otherwise. It will be further understood that the terms “comprises,” “comprising,” “includes,” and “including” when used in this specification, specify the presence of the stated elements and do not preclude the presence or addition of one or more other elements. As used herein, the term “and/or” includes any and all combinations of one or more of the associated listed items.

Unless otherwise defined, all terms including technical and scientific terms used herein have the same meaning as commonly understood by one of ordinary skill in the art to which the present invention belongs in view of the present disclosure. It will be further understood that terms, such as those defined in commonly used dictionaries, should be interpreted as having a meaning that is consistent with their meaning in the context of the present disclosure and the relevant art, and will not be interpreted in an idealized or overly formal sense unless expressly so defined herein.

In the following description, numerous specific details are set forth in order to provide a thorough understanding of the present invention. The present invention may be practiced without some or all of these specific details. In other instances, well-known process structures and/or processes have not been described in detail in order not to unnecessarily obscure the present invention.

It is also noted, that in some instances, as would be apparent to those skilled in the relevant art, a feature or element described in connection with one embodiment may be used singly or in combination with other features or elements of another embodiment, unless otherwise specifically indicated.

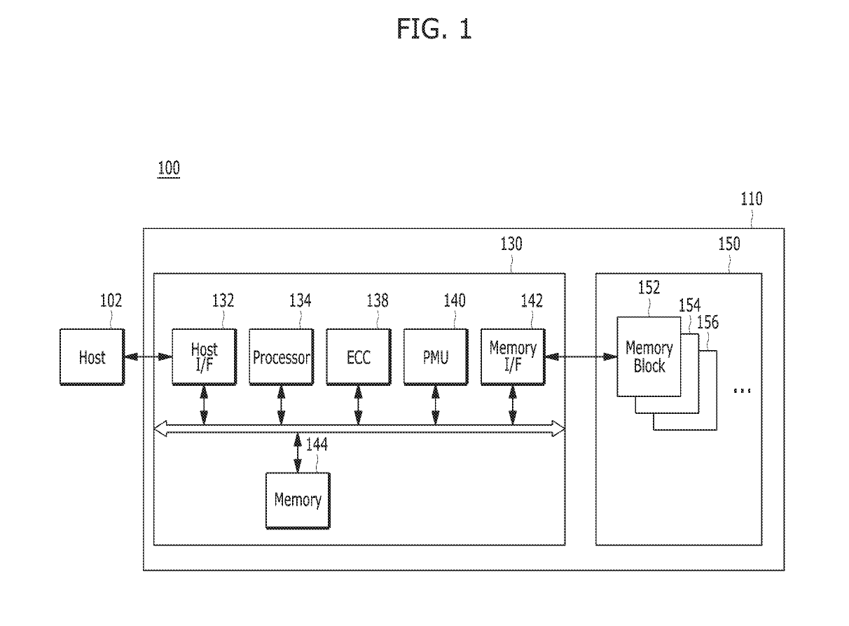

FIG. 1 is a block diagram illustrating a data processing system 100 including a memory system 110 in accordance with an embodiment of the present invention.

Referring to FIG. 1, the data processing system 100 may include a host 102 and the memory system 110.

By way of example but not limitation, the host 102 may include portable electronic devices such as a mobile phone, MP3 player and laptop computer or non-portable electronic devices such as a desktop computer, a game machine, a TV and a projector.

The memory system 110 may operate to store data for the host 102 in response to a request by the host 102. Non-limited examples of the memory system 110 may include a solid state drive (SSD), a mufti-media card (MMC), a secure digital (SD) card, a universal storage bus (USB) device, a universal flash storage (UFS) device, compact flash (CF) card, a smart media card (SMC), a personal computer memory card international association (PCMCIA) card and memory stick. The MMC may include an embedded MMC (eMMC), reduced size MMC (RS-MMC) and micro-MMC. The SD card may include a mini-SD card and micro-SD card.

The memory system 110 may be embodied by various types of storage devices. Non-limited examples of storage devices included in the memory system 110 may include volatile memory devices such as a DRAM dynamic random access memory (DRAM) and a static RAM (SRAM) and nonvolatile memory devices such as a read only memory (ROM), a mask ROM (MROM), a programmable ROM (PROM), an erasable programmable ROM (EPROM), an electrically erasable programmable ROM (EEPROM), a ferroelectric RAM (FRAM), a phase-change RAM (PRAM), a magneto-resistive RAM (MRAM), a resistive RAM (RRAM) and a flash memory. The flash memory may have a 3-dimensioanl (3D) stack structure.

The memory system 110 may include a memory device 150 and a controller 130. The memory device 150 may store data for the host 120. The controller 130 may control data storage into the memory device 150.

In an example, the controller 130 and the memory device 150 may be integrated into a single semiconductor device, which may be included in the various types of memory systems as described above.

Non-limited application examples of the memory system 110 may include a computer, an Ultra Mobile PC (UMPC), a workstation, a net-book, a Personal Digital Assistant (PDA), a portable computer, a web tablet, a tablet computer, a wireless phone, a mobile phone, a smart phone, an e-book, a Portable Multimedia Player (PMP), a portable game machine, a navigation system, a black box, a digital camera, a Digital Multimedia Broadcasting (DMB) player, a 3-dimensional television, a smart television, a digital audio recorder, a digital audio player, a digital picture recorder, a digital picture player, a digital video recorder, a digital video player, a storage device constituting a data center, a device capable of transmitting/receiving information in a wireless environment, one of various electronic devices constituting a home network, one of various electronic devices constituting a computer network, one of various electronic devices constituting a telematics network, a Radio Frequency Identification (RFID) device, or one of various components constituting a computing system.

In an example, the memory device 150 may be a nonvolatile memory device and may retain data stored therein even though power is not supplied. The memory device 150 may store data provided from the host 102 through a write operation. The memory device 150 may output data stored therein to the host 102 through a read operation. The memory device 150 may include a plurality of memory dies (not shown). Each memory die may include a plurality of planes (not shown). Each plane may include a plurality of memory blocks 152 to 156. Each of the memory blocks 152 to 156 may include a plurality of pages. Each of the pages may include a plurality of memory cells coupled to a word line.

The controller 130 may control the memory device 150 in response to a request from the host 102. By way of example but not limitation, the controller 130 may provide data read from the memory device 150 to the host 102, and store data provided from the host 102 into the memory device 150. For this operation, the controller 130 may control read, write, program and erase operations of the memory device 150.

The controller 130 may include a host interface (I/F) unit 132, a processor 134, an error correction code (ECC) unit 138, a Power Management Unit (PMU) 140, a NAND flash controller (NFC) 142 and a memory 144. Each of the components may be electrically coupled, or engaged with, each other via an internal bus.

The host interface unit 132 may be configured to process a command and data of the host 102, and may communicate with the host 102 through one or more of various interface protocols such as universal serial bus (USB), multi-media card (MMC), peripheral component interconnect-express (PCI-E), small computer system interface (SCSI), serial-attached SCSI (SAS), serial advanced technology attachment (SATA), parallel advanced technology attachment (PATA), enhanced small disk interface (ESDI) and integrated drive electronics (IDE).

The ECC unit 138 may detect and correct an error contained in the data read from the memory device 150. In other words, the ECC unit 138 may perform an error correction decoding process to the data read from the memory device 150 through an ECC code used during an ECC encoding process. According to a result of the error correction decoding process, the ECC unit 138 may output a signal, for example, an error correction success or fail signal. When the number of error bits is more than a threshold value of correctable error bits, the ECC unit 138 may not correct the error bits and may output the error correction fail signal.

The ECC unit 138 may perform error correction through a coded modulation such as Low Density Parity Check (LDDC) code, Bose-Chaudhri-Hocquenghem (BCH) code, turbo code, Reed-Solomon code, convolution code, Recursive Systematic Code (RSC), Trellis-Coded Modulation (TCM) and Block coded modulation (BCM). However, the ECC unit 138 is not limited thereto. The ECC unit 138 may include all circuits, modules, systems or devices for error correction.

The PMU 140 may manage an electrical power used and provided to the controller 130.

The NFC 142 may serve as a memory/storage interface for interfacing the controller 130 and the memory device 150 such that the controller 130 controls the memory device 150 in response to a request from the host 102. When the memory device 150 is a flash memory or specifically a NAND flash memory, the NFC 142 may generate a control signal for the memory device 150 and process data, inputted to the memory device 150, under the control of the processor 134. The NFC 142 may work as an interface (e.g., a NAND flash interface) for processing a command and data between the controller 130 and the memory device 150. Specifically, the NFC 142 may support data transmission between the controller 130 and the memory device 150.

The memory 144 may serve as a working memory of the memory system 110 and the controller 130. The memory 144 may store data supporting the operation of the memory system 110 and the controller 130. The controller 130 may control the memory device 150 so that read, write, program and erase operations are performed in response to a request from the host 102. The controller 130 may output data read from the memory device 150 to the host 102, and may store data provided from the host 102 into the memory device 150. The memory 144 may store data required for the controller 130 and the memory device 150 to perform these operations.

The memory 144 may be embodied by a volatile memory. By way of example but not limitation, the memory 144 may be embodied by a static random access memory (SRAM) or a dynamic random access memory (DRAM). The memory 144 may be disposed within or out of the controller 130. FIG. 1 exemplifies an embodiment of the memory 144 disposed within the controller 130. In another embodiment, the memory 144 may be embodied by an external volatile memory having a memory interface transferring data between the memory 144 and the controller 130.

The processor 134 may control the overall operations of the memory system 110. The processor 134 may use a firmware to control overall operations of the memory system 110. The firmware may be referred to as a flash translation layer (FTL).

The processor 134 of the controller 130 may include a management unit (not illustrated) for performing a bad block management operation of the memory device 150. The management unit may perform a bad block management operation of checking a bad block among the plurality of memory blocks 152 to 156 included in the memory device 150. The bad block may include a block in which a program fail occurs during a program operation, due to the characteristic of a NAND flash memory. The management unit may write the program-failed data of the bad block to a new memory block. In the memory device 150 having a 3D stack structure, the bad block management operation may reduce the use efficiency of the memory device 150 and the reliability of the memory system 110. Thus, the bad block management operation needs to be performed with more reliability.

Also, in a memory system in accordance with an embodiment of the present disclosure, the controller 130 performs a plurality of command operations, corresponding to a plurality of commands delivered from the host 102, in the memory device 150. By way of example but not limitation, the controller 130 may perform, in the memory device 150, a plurality of program operations corresponding to a plurality of write commands, a plurality of read operations corresponding to a plurality of read commands and a plurality of erase operations corresponding to a plurality of erase commands. When performing the command operations, the controller 130 may update a metadata such as a map data. In the memory system in accordance with the embodiment of the present disclosure, the controller 130 performs command operations corresponding to the plurality of commands received from the host 102, in the plurality of memory blocks included in the memory device 150, and the controller 130 performs command operations and a swap operation in the memory blocks of the memory device 150 in consideration of parameters for the memory device 150 in correspondence to the performing of the command operations. Since characteristic degradations may occur in the plurality of memory blocks in correspondence to the performing of the command operations and, the operational reliability of the memory device 150 may deteriorate.

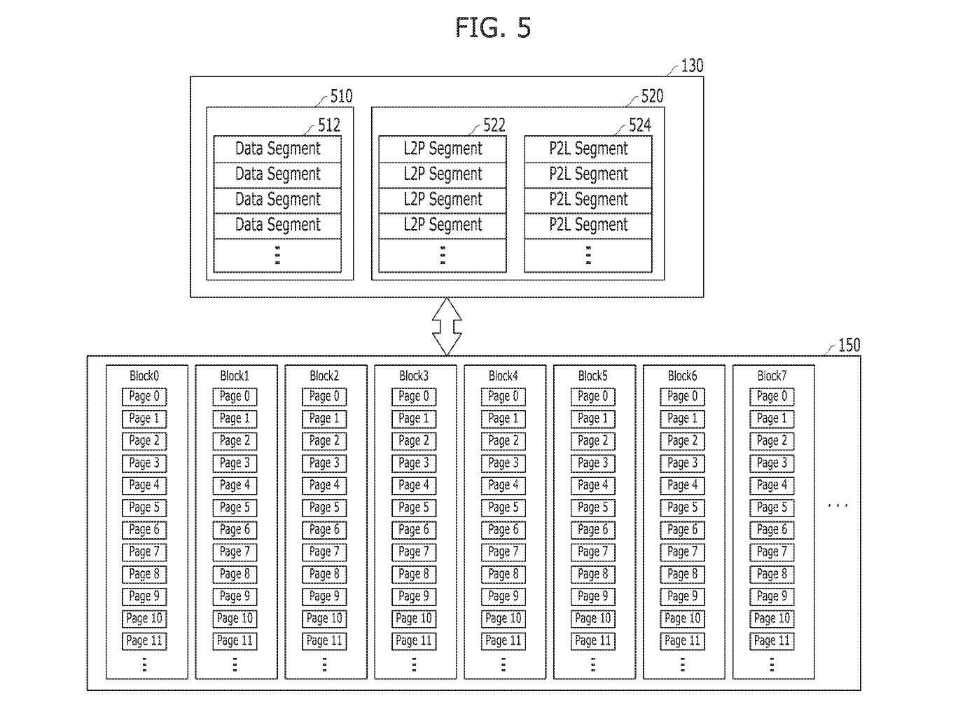

In the memory system in accordance with the embodiment of the present disclosure, characteristic degradations may occur in memory blocks while the controller 130 performs command operations in the plurality of memory blocks included in the memory device 150. When command operations are performed for the memory blocks in which such characteristic degradations occur, failures may occur while performing the command operations. Therefore, in the memory system in accordance with the embodiment of the present disclosure, in correspondence to the command operations performed in the plurality of memory blocks, the controller 130 checks parameters for the memory blocks. When the erase operations and program operations are performed in the plurality of memory blocks, the controller 130 checks erase counts, program counts, program/erase (P/E) cycles or erase/write (E/W) cycles. To minimize the occurrence of failures when performing command operations due to characteristic degradations in the memory blocks, the controller 130 performs command operations and a swap operation in consideration of the memory block parameters. Since detailed descriptions will be made below with reference to FIGS. 5 to 8 for performing of command operations and a swap operation in consideration of the parameters for the memory blocks of the memory device 150 in the memory system in accordance with the embodiment of the present disclosure, further descriptions thereof will be onr itted herein.

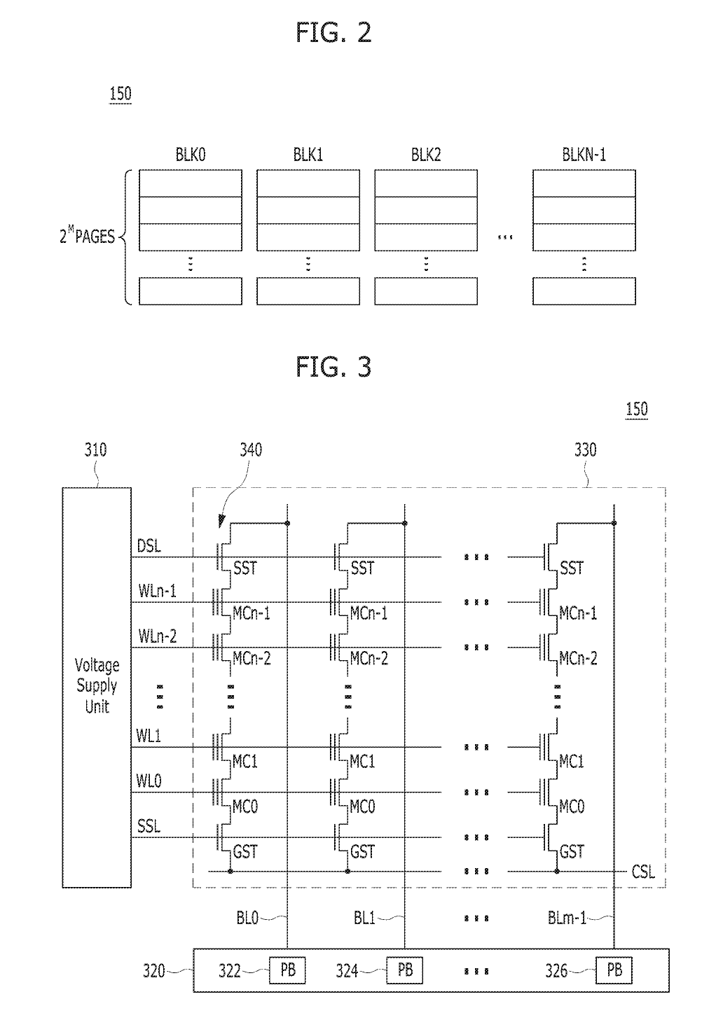

A management unit (not shown) for performing bad management for the memory device 150 may be included in the processor 134 of the controller 130. The management unit checks a bad block in the plurality of memory blocks 152, 154, 156 included in the memory device 150. The management unit performs bad block management of processing a checked bad block as a bad. Bad block management means that, when the memory device 150 is a flash memory, for example, a NAND flash memory, a program failure may occur when performing data write such as data program onto a memory block where the program failure has occurred, the memory block is determined as a bad due to the characteristic of the NAND flash memory. The bad block management allows program-failed data to be written, that is, programmed, into a new memory block. Moreover, when the memory device 150 has a 3-dimensional stack structure as described above, it is necessary to reliably perform bad block management when a corresponding memory block is determined as a bad block according to a program fail since the utilization efficiency of the memory device 150 and the reliability of the memory system 110 may deteriorate abruptly. Hereinbelow, a memory device in the memory system in accordance with the embodiment of the present disclosure will be described in detail with reference to FIGS. 2 to 4.

FIG. 2 is a schematic diagram illustrating the memory device 150.

Referring to FIG. 2, the memory device 150 may include a plurality of memory blocks 0 to N-1, and each of the blocks 0 to N-1 may include a plurality of pages, for example, 2^{M} pages, the number of which may vary according to circuit design. Memory cells included in the respective memory blocks 0 to N-1 may be one or more of a single level cell (SLC) storing 1-bit data, or a multi-level cell (MLC) storing 2- or more bit data. In an embodiment, the memory device 150 may include a plurality of triple level cells (TLC), each storing 3-bit data. In another embodiment, the memory device may include a plurality of quadruple level cells (QLC), each storing 4-bit level cell.

FIG. 3 is a circuit diagram illustrating an exemplary configuration of a memory cell array of a memory block in the memory device 150.

Referring to FIG. 3, a memory block 330 which may correspond to any of the plurality of memory blocks 152 to 156 included in the memory device 150 of the memory system 110 may include a plurality of cell strings 340 coupled to a plurality of corresponding bit lines BL0 to BLm-1. The cell string 340 of each column may include one or more drain select transistors DST and one or more source select transistors SST. Between the drain and source select transistors DST, SST, a plurality of memory cells MC0 to MCn-1 may be coupled in series. In an embodiment, each of the memory cell transistors MC0 to MCn-1 may be embodied by an MLC capable of storing data information of a plurality of bits. Each of the cell strings 340 may be electrically coupled to a corresponding bit line among the plurality of bit lines BL0 to BLm-1. For example, as illustrated in FIG. 3, the first cell string is coupled to the first bit line BL0, and the last cell string is coupled to the last bit line BLm-1.

Although FIG. 3 illustrates NAND flash memory cells, the invention is not limited in this way. It is noted that the memory cells may be NOR flash memory cells, or hybrid flash memory cells including two or more kinds of memory cells combined therein. Also, it is noted that the memory device 150 may be a flash memory device including a conductive floating gate as a charge storage layer or a charge trap flash (CTF) memory device including an insulation layer as a charge storage layer.

The memory device 150 may further include a voltage supply unit 310 which provides word line voltages including a program voltage, a read voltage and a pass voltage to supply to the word lines according to an operation mode. The voltage generation operation of the voltage supply unit 310 may be controlled by a control circuit (not illustrated). Under the control of the control circuit, the voltage supply unit 310 may select one of the memory blocks (or sectors) of the memory cell array, select one of the word lines of the selected memory block, and provide the word line voltages to the selected word line and the unselected word lines as may be needed.

The memory device 150 may include a read/write circuit 320 which is controlled by the control circuit. During a verification/normal read operation, the read/write circuit 320 may operate as a sense amplifier for reading data from the memory cell array. During a program operation, the read/write circuit 320 may operate as a write driver for driving bit lines according to data to be stored in the memory cell array. During a program operation, the read/write circuit 320 may receive from a buffer (not illustrated) data to be stored into the memory cell array, and may supply a current or a voltage onto bit lines according to the received data. The read/write circuit 320 may include a plurality of page buffers 322 to 326 respectively corresponding to columns (or bit lines) or column pairs (or bit line pairs). Each of the page buffers 322 to 326 may include a plurality of latches (not illustrated).

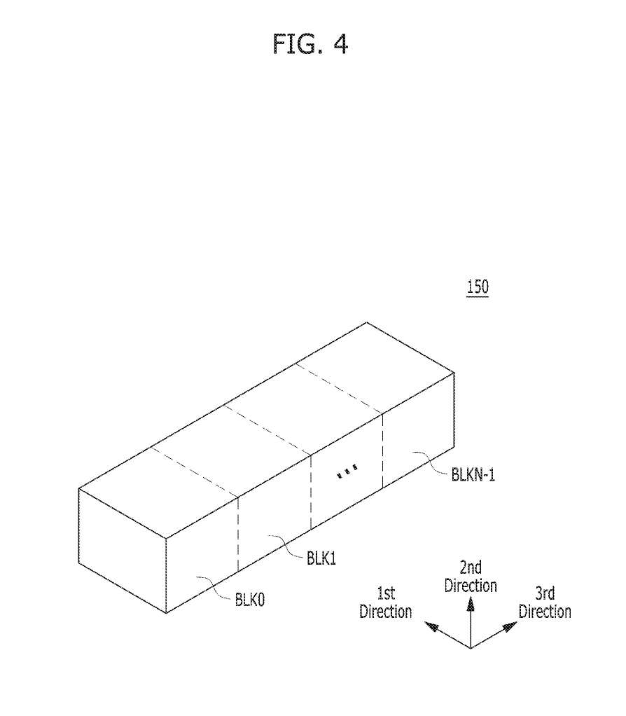

FIG. 4 is a schematic diagram illustrating an exemplary 3D structure of the memory device 150.

The memory device 150 may be embodied by a 2D or 3D memory device. Specifically, as illustrated in FIG. 4, the memory device 150 may be embodied by a nonvolatile memory device having a 3D stack structure. When the memory device 150 has a 3D structure, the memory device 150 may include a plurality of memory blocks BLK0 to BLKN-1, each having a 3D structure (or vertical structure).

Hereinbelow, detailed descriptions will be made with reference to FIGS. 5 to 8 for a data processing operation with respect to the memory device 150 in the memory system in accordance with the embodiment. During the data processing operation, a plurality of commands are entered from the host 102 so that a plurality of command operations corresponding to the commands are performed.

FIGS. 5 to 7 are examples of schematic diagrams of a data processing operation when a plurality of command operations corresponding to a plurality of commands are performed in a memory system in accordance with an embodiment. In the embodiment of the present disclosure, detailed descriptions will be made by taking as an example a case in which, in the memory system 110 shown in FIG. 1, a plurality of commands are received from the host 102 and command operations corresponding to the commands are performed. In the embodiment of the present disclosure, detailed descriptions will be made for a data processing operation. For example, when a plurality of write commands are entered from the host 102, program operations corresponding to the write commands may be performed. When a plurality of read commands are delivered from the host 102, read operations corresponding to the read commands may be performed. When a plurality of erase commands are received from the host 102, erase operations corresponding to the erase commands may be performed. Otherwise, when a plurality of write commands and a plurality of read commands are entered together from the host 102, program operations and read operations corresponding to the write commands and the read commands may be performed.

Moreover, in an embodiment of the present disclosure, descriptions will be made by taking as an example a case in which write data stored in the buffer/cache are programmed to, and stored in, the plurality of memory blocks included in the memory device 150 after the write data, corresponding to a plurality of write commands entered from the host 102, are stored in the buffer/cache included in the memory 144 of the controller 130. Then, after map data in correspondence to the storing of the write data in the plurality of memory blocks is updated, the updated map data are stored in the plurality of memory blocks included in the memory device 150. In an embodiment of the present disclosure, descriptions will be made by taking as an example a case in which program operations, corresponding to a plurality of write commands received from the host 102, are performed. Furthermore, in the embodiment of the present disclosure, descriptions will be made by taking as an example a case in which a plurality of read commands are entered from the host 102 for the data stored in the memory device 150, then data corresponding to the read commands are outputted from the memory device 150 based on the map data of the data corresponding to the read commands. Then, after the read data are stored in the buffer/cache included in the memory 144 of the controller 130, the data stored in the buffer/cache are outputted to the host 102. In other words, in the embodiment of the present disclosure, descriptions will be made by taking as an example a case in which read operations, corresponding to a plurality of read commands received from the host 102, are performed. In addition, in the embodiment of the present disclosure, descriptions will be made by taking as an example a case in which a plurality of erase commands are received from the host 102 for the memory blocks included in the memory device 150. When memory blocks corresponding to the erase commands are identified, the data stored in the identified memory blocks are erased. When a map data corresponding to the erased data is updated, the updated map data are stored in the plurality of memory blocks included in the memory device 150. Namely, in the embodiment of the present disclosure, descriptions will be made by taking as an example a case in which erase operations corresponding to a plurality of erase commands received from the host 102 are performed.

Further, in the present embodiment, it will be described below as an example that the controller 130 performs command operations in the memory system 110. It is to be noted that, as described above, the processor 134 included in the controller 130 may perform command operations in the memory system 110 through, for example, an FTL (flash translation layer). Also, in an embodiment of the present disclosure, the controller 130 programs and stores user data and metadata corresponding to write commands received from the host 102, in predetermined memory blocks among the plurality of memory blocks included in the memory device 150. The controller 130 reads user data and metadata corresponding to read commands received from the host 102, from the predetermined memory blocks among the is plurality of memory blocks included in the memory device 150, and provides the read data to the host 102. The controller 130 erases user data and metadata corresponding to erase commands received from the host 102, from the predetermined memory blocks among the plurality of memory blocks included in the memory device 150.

Metadata may include first map data including a logical/physical (L2P: logical to physical) information (hereinafter, referred to as a ‘logical information’) and second map data including a physical/logical (P2L: physical to logical) information (hereinafter, referred to as a ‘physical information’), for data stored in memory blocks corresponding to a program operation. Also, the metadata may include an information on command data corresponding to a command received from the host 102, an information on a command operation corresponding to the command, an information on the memory blocks of the memory device 150 for which the command operation is to be performed, and an information on map data corresponding to the command operation. In other words, metadata may include all remaining informations and data, required to perform the operation responsive to the command with user data, excluding the user data corresponding to a command received from the host 102.

In an embodiment of the present disclosure, in the case in which the controller 130 receives a plurality of write commands with user data from the host 102, program operations corresponding to the write commands are performed so that the user data corresponding to the write commands are written and stored in empty memory blocks. To store the user data, an erase operation may be performed at open memory blocks or free memory blocks among the memory blocks of the memory device 150. Also, a first map data and a second map data are written and stored in at least one empty memory block, at least one open memory block or at least one free memory block among the memory blocks of the memory device 150. Here, the first map data may include an L2P map table or an L2P map list in which logical information for mapping logical addresses with physical addresses for the user data stored in the memory blocks are recorded. The second map data may include a P2L map table or a P2L map list in which physical information for mapping physical addresses with logical addresses for the memory blocks stored with the user data are recorded.

Here, when write commands are received from the host 102, the controller 130 writes and stores user data corresponding to the write commands in memory blocks. The controller 130 stores, in memory blocks, metadata including a first map data and a second map data for the user data stored in the memory blocks. Corresponding to the data segments of the user data which are stored in the memory blocks of the memory device 150, the controller 130 generates and updates the L2P segments of first map data and the P2L segments of second map data as map segments of map data among the meta segments of metadata. Then, the controller 130 stores the map segments in the memory blocks of the memory device 150. The map segments stored in the memory blocks of the memory device 150 are loaded in the memory 144 included in the controller 130 and are then updated.

Further, when a plurality of read commands are received from the host 102, the controller 130 accesses and reads read data, corresponding to the read commands, from the memory device 150. The controller 130 stores the read data in the buffers/caches included in the memory 144 of the controller 130, and then, outputs the data, stored in the buffers/caches, to the host 102. The read operations, each including consecutive sub operations, are performed in response to the plurality of read commands.

In addition, when a plurality of erase commands are received from the host 102, the controller 130 checks memory blocks of the memory device 150 corresponding to the erase commands, and then, performs erase operations for the memory blocks. Hereinbelow, a data processing operation in the memory system in accordance with the embodiment of the present disclosure will be described in detail with reference to FIGS. 5 to 7.

First, referring to FIG. 5, the controller 130 performs command operations corresponding to a plurality of commands received from the host 102. For example, the controller 130 performs program operations corresponding to a plurality of write commands received from the host 102. In the program operations, the controller 130 programs and stores user data, entered with the write commands, in memory blocks of the memory device 150. Also, corresponding to the memory blocks where the program operations are performed, the controller 130 generates and updates metadata for the user data and stores the metadata in the memory blocks of the memory device 150.

The controller 130 generates and updates first map data and second map data which include informations indicating that the user data are stored in pages included in the memory blocks of the memory device 150. The controller 130 generates, and updates, L2P segments as the logical segments of the first map data and P2L segments as the physical segments of the second map data. The controller 130 stores the L2P segments and P2L segments in pages included in the memory blocks of the memory device 150.

By way of example but not limitation, the controller 130 caches and buffers the user data, corresponding to the write commands received from the host 102, in a first buffer 510 included in the memory 144 of the controller 130. After storing data segments 512 of the user data in the first buffer 510 as a data buffer/cache, the controller 130 copies the data segments 512, stored in the first buffer 510, in at least one page included in the memory blocks of the memory device 150. When the data segments 512 of the user data corresponding to the write commands received from the host 102 are programmed to, and stored in, the pages included in the memory blocks of the memory device 150, the controller 130 generates, and updates, the first map data and the second map data, and stores the first map data and second map data in a second buffer 520 included in the memory 144 of the controller 130. The controller 130 stores L2P segments 522 of the first map data and P2L segments 524 of the second map data for the user data, in the second buffer 520 as a map buffer/cache. The second buffer 520 in the memory 144 of the controller 130 may include the L2P segments 522 of the first map data and the P2L segments 524 of the second map data. Otherwise, the second buffer 520 includes a map list for the L2P segments 522 of the first map data and a map list for the P2L segments 524 of the second map data. The controller 130 stores the L2P segments 522 of the first map data and the P2L segments 524 of the second map data, which are stored in the second buffer 520, in at least one page included in the memory blocks of the memory device 150.

Furthermore, the controller 130 performs command operations corresponding to a plurality of commands received from the host 102. For example, the controller 130 performs read operations corresponding to a plurality of read commands received from the host 102. The controller 130 loads L2P segments 522 of first map data and P2L segments 524 of second map data as the map segments of user data corresponding to the read commands, in the second buffer 520. The controller 130 checks the L2P segments 522 and the P2L segments 524. The controller 130 reads the user data stored in pages of memory blocks among the memory blocks of the memory device 150, which are corresponding to the L2P segments 522 and the P2L segments 524. The controller 130 stores data segments 512 of the read user data in the first buffer 510, and then outputs the data segments 512 to the host 102.

Furthermore, the controller 130 performs command operations corresponding to a plurality of commands received from the host 102. For example, the controller 130 performs erase operations corresponding to a plurality of erase commands received from the host 102. The controller 130 checks memory blocks corresponding to the erase commands among the memory blocks of the memory device 150, and performs the erase operations for the checked memory blocks.

When performing an operation of copying data or swapping data among the memory blocks included in the memory device 150 as a background operation such as a garbage collection operation or a wear leveling operation, the controller 130 stores data segments 512, corresponding user data, in the first buffer 510. The controller 130 loads map segments 522 and 524 of map data, corresponding to the user data, from the second buffer 520. Then, the controller 130 performs the garbage collection operation or the wear leveling operation.

When performing command operations in the memory blocks of the memory device 150 as described above, the controller 130 checks parameters for the memory blocks of the memory device 150. The controller 130 performs command operations and a swap operation in the memory blocks of the memory device 150 in consideration of the parameters for the memory blocks. As the parameters for the memory blocks of the memory device 150, the controller 130 checks erase counts, program counts, program/erase (P/E) cycles or erase/write (E/W) cycles in correspondence to erase operations and program operations in the memory blocks of the memory device 150.

The controller 130 skips allocation of memory blocks for performing command operations and performs a swap operation, in consideration of the parameters for the memory blocks of the memory device 150. By way of example but not limitation, when determining empty memory blocks, open memory blocks or free memory blocks in the memory blocks of the memory device 150 as target memory blocks for the program operations, the controller 130 skips preparing target memory blocks for the program operations and allocates the target memory blocks to the swap operation, based on the parameters for the memory blocks. When performing the program operations in the memory blocks of the memory device 150, the controller 130 may sequentially allocate target memory blocks for the program operations, among the memory blocks, to each program operation through a round robin scheduling scheme. The controller 130 may skip allocated target memory blocks for program operations based on the parameters for the memory blocks. The controller 130 may allocate memory blocks, which are skipped among allocated target memory blocks for program operations, to swap operations.

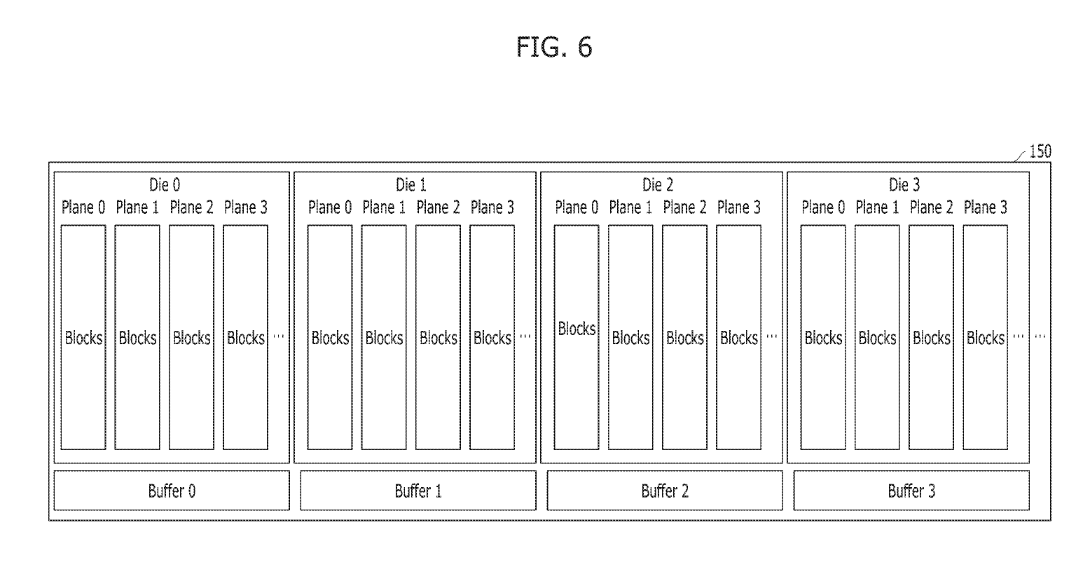

Referring to FIG. 6, the memory device 150 includes a plurality of memory dies, for example, a memory die 0, a memory die 1, a memory die 2 and a memory die 3. Each of the memory dies may include a plurality of planes, for example, a plane 0, a plane 1, a plane 2 and a plane 3. The respective planes in the memory dies included in the memory device 150 include a plurality of memory blocks, for example, N number of blocks Block0, Block1, . . . , BlockN-1, each including a plurality of pages, for example, 2̂ M number of pages, as described above with reference to FIG. 2. Moreover, the memory device 150 includes a plurality of buffers corresponding to the respective memory dies, for example, a buffer 0 corresponding to the memory die 0, a buffer 1 corresponding to the memory die 1, a buffer 2 corresponding to the memory die 2 and a buffer 3 corresponding to the memory die 3.

When performing command operations corresponding to a plurality of commands received from the host 102, data corresponding to the command operations are stored in the buffers included in the memory device 150. By way of example but not limitation, when performing program operations, data corresponding to the program operations are stored in the buffers. The data stored in the buffers are then stored in the pages included in the memory blocks of the memory dies. When performing read operations, data corresponding to the read operations are read from the pages included in the memory blocks of the memory dies. The read data are stored in the buffers. The data stored in the buffers are then outputted to the host 102 through the controller 130.

In an embodiment of the present disclosure, the buffers included in the memory device 150 exist outside the respective corresponding memory dies, however the buffers may exist inside the respective corresponding memory dies. The buffers may correspond to the respective planes or the respective memory blocks in the respective memory dies. Further, in the embodiment of the present disclosure, the buffers included in the memory device 150 are the plurality of page buffers 322, 324, 326 included in the memory device 150 as described above with reference to FIG. 3, however may be a plurality of caches or a plurality of registers included in the memory device 150.

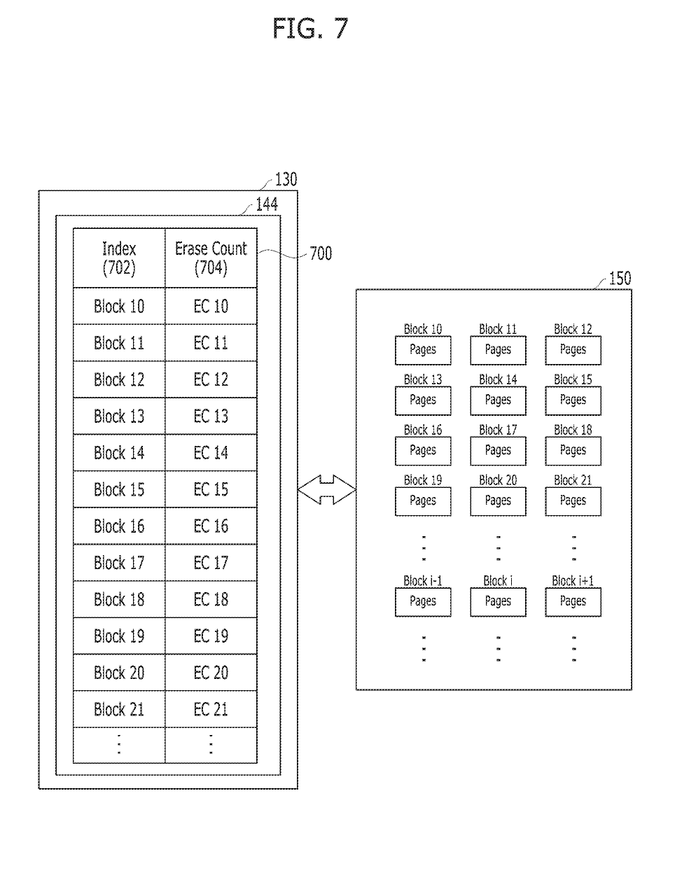

Also, the plurality of memory blocks included in the memory device 150 may be grouped into a plurality of super memory blocks, and command operations may be performed in the plurality of super memory blocks. Each of the super memory blocks may include a plurality of memory blocks, for example, memory blocks included in a first memory block group and a second memory block group. When the first memory block group is included in the first plane of a certain first memory die, the second memory block group may be included in the first plane of the first memory die, the second plane of the first memory die or the planes of a second memory die. Hereinbelow, detailed descriptions will be made through an example with reference to FIG. 7 for performing command operations, corresponding to the is plurality of commands received from the host 102, in the plurality of memory blocks included in the memory device 150, checking parameters for the respective memory blocks corresponding to performing the command operations and performing command operations and a swap operation in the memory blocks of the memory device 150 in consideration of the parameters.

While descriptions will be made in the embodiment of the present disclosure for the sake of convenience in explanation by taking an example in which, when performing erase operations in the memory blocks of the memory device 150 after checking erase counts for the memory blocks, command operations and a swap operation are performed in the memory blocks of the memory device 150 in consideration of the erase counts. Furthermore, the present disclosure may be applied even when command operations and a swap operation are performed in the memory blocks of the memory device 150 in consideration of not only parameters, for example, program counts, program/erase cycles or erase/write cycles which correspond to performing erase operations and program operations, as described above, but also parameters, for example, read counts or read reclaim counts, which correspond to performing read operations. Additionally, when command operations, in particular, program operations and a swap operation, are performed in the memory blocks of the memory device 150 in consideration of erase counts, the present disclosure may also be applied even when a foreground operation including command operations and a copy operation as a background operation are performed.

Referring to FIG. 7, when receiving a plurality of commands, for example, a plurality of write commands, a plurality of read commands and a plurality of erase commands, from the host 102, the controller 130 performs command operations corresponding to the plurality of commands received from the host 102, for example, program operations, read operations and erase operations, in the plurality of memory blocks included in the memory device 150. Corresponding to the command operations performed in the memory blocks of the memory device 150, the controller 130 checks parameters for the memory blocks of the memory device 150, and performs command operations and a swap operation, for example, a wear leveling operation, for the memory blocks of the memory device 150 in consideration of the parameters.

When allocating target memory blocks to command operations, in particular, program operations, in the memory blocks of the memory device 150, the controller 130 sequentially allocates target memory blocks among the memory blocks through a round robin scheduling scheme, and skips allocation of optional memory blocks as target memory blocks for program operations, in consideration of the parameters for the memory blocks. The controller 130 allocates optional memory blocks of which allocation as target memory blocks for performing of the program operations is skipped, as target memory blocks for swap operations.

In detail, when receiving erase commands from the host 102, the controller 130 performs erase operations corresponding to the erase commands received from the host 102, in the plurality of memory blocks included in the memory device 150, for example, a memory block 10, a memory block 11, a memory block 12, a memory block 13, a memory block 14, a memory block 15, a memory block 16, a memory block 17, a memory block 18, a memory block 19, a memory block 20 and a memory block 21. The controller 130 checks parameters for the respective memory blocks, corresponding to performing of the erase operations in the memory blocks. The controller 130 checks erase counts 704 of the respective memory blocks, as the parameters corresponding to performing of the erase operations in the memory blocks. The controller 130 records the erase counts 704 checked for the memory blocks, respectively, in a parameter table 700 by indexes 702 of the memory blocks. The parameter table 700 may be metadata for the memory device 150. Therefore, the parameter table 700 is stored in the memory 144 of the controller 130, e.g., the second buffer 520 included in the memory 144 of the controller 130. The parameter table 700 may also be stored in the memory device 150.

When receiving write commands from the host 102, the controller 130 performs program operations corresponding to the write commands received from the host 102, in the memory blocks of the memory device 150. In particular, the controller 130 sequentially allocates target memory blocks for performing program operations, in the round robin scheduling scheme, among the plurality of memory blocks included in the memory device 150, for example, the memory block 10, the memory block 11, the memory block 12, the memory block 13, the memory block 14, the memory block 15, the memory block 16, the memory block 17, the memory block 18, the memory block 19, the memory block 20 and the memory block 21. The controller 130 checks the erase counts 704 of the respective memory blocks recorded in the parameter table 700, as parameters for the memory blocks. The controller 130 allocates target memory blocks for performing program operations, in consideration of the erase counts 704 of the respective memory blocks.

The controller 130 skips allocation of first memory blocks among the memory blocks, of which erase counts 704 exceed a first threshold value, as target memory blocks for program operations. The controller 130 skips the first memory blocks when allocating target memory blocks for program operations, through the round robin scheduling scheme, among the memory blocks of the memory device 150. The controller 130 sequentially allocates second memory blocks among the memory blocks, of which erase counts 704 are equal to or less than the first threshold value, as target memory blocks. After allocating target memory blocks among the second memory blocks, the controller 130 performs program operations. The controller 130 allocates the first memory blocks of which erase counts 704 exceed the first threshold is value in the parameter table 700, as target memory blocks for swap operations, and performs swap operations, e.g., a wear leveling operation, for the first memory blocks. The first memory blocks of which erase counts 704 exceed the first threshold value become candidate memory blocks which are to be allocated as target memory blocks for swap operations, and the second memory blocks of which erase counts 704 are equal to or less than the first threshold value become candidate memory blocks which are to be allocated as target memory blocks for program operations.

The controller 130 determines the first threshold value corresponding to the erase counts 704 of the respective memory blocks which are recorded in the parameter table 700. For instance, the controller 130 determines the average count of the erase counts 704 of the respective memory blocks recorded in the parameter table 700, as the first threshold value, determines a calculation value (for example, the middle value) of a minimum count and a maximum count, as the first threshold value, or determines a calculation value through a predetermined metric, as the first threshold value.

After skipping the allocation of the first memory blocks among the memory blocks, of which erase counts 704 exceed the first threshold value, as target memory blocks for performing program operations, the controller 130 counts the number of the first memory blocks of which allocation as target memory blocks is skipped. The controller 130 records the skipped first memory blocks in the parameter table 700. The controller 130 may record the number of the first memory blocks in the parameter table 700. Corresponding to the counted number of the first memory blocks, the controller 130 adjusts the triggering rate of a swap operation to be performed for the first memory blocks. For example, as the counted number of the first memory blocks increases, the controller 130 increases the triggering rate of a swap operation such that swap operations for the first memory blocks are frequently performed.

When the counted number of the first memory blocks exceeds a second threshold value, the controller 130 adjusts the first threshold value. When allocating target memory blocks for program operations among the memory blocks of the memory device 150 through the round robin scheduling scheme, when the number of the skipped first memory blocks exceeds the second threshold value, the number of second memory blocks which are to be allocated as target memory blocks for performing program operations may be insufficient, and therefore, the controller 130 adjusts the first threshold value. That is when the number of the skipped first memory blocks exceeds the second threshold value, the controller 130 calculates a threshold offset and decreases the first threshold value by the threshold offset. Accordingly, the number of first memory blocks to be skipped may be decreased in correspondence to the decreased first threshold value. The number of second memory blocks to be allocated as target memory blocks through the round robin scheduling scheme may be increased.

The controller 130 determines the second threshold value corresponding to the number of target memory blocks necessary to allocate for performing program operations and the number of second memory blocks to be allocated as target memory blocks. The controller 130 determines the second threshold value corresponding to the number of target memory blocks allocated for program operations and the number of candidate memory blocks. For instance, the controller 130 may determine, as the second threshold value, the average number of the number of target memory blocks and the number of second memory blocks. In another example, the controller 130 may determine, as the second threshold value, a calculation value (e.g., the minimum number) between the number of target memory blocks and the number of second memory blocks. In another example, the controller 130 may determine, as the second threshold value, a calculation value through a predetermined metric.

Furthermore, the controller 130 calculates a threshold offset corresponding to the first memory blocks which are skipped since the erase counts 704 exceed the first threshold value. is, after checking the erase counts 704 of first memory blocks in the parameter table 700, the controller 130 calculates the threshold offset corresponding to the erase counts 704 of the first memory blocks. For instance, the controller 130 calculates, as the threshold offset, the offset between the average count for the erase counts of the first memory blocks and the first threshold value. In another example, the controller 130 calculates, as the threshold offset, the offset between a calculation value (for example, the middle value) of a minimum count and a maximum count and the first threshold value. In another example, the controller 130 calculates, as the threshold offset, the offset between a calculation value through a predetermined metric and the first threshold value.

After dynamically adjusting the first threshold value through the threshold offset, the controller 130 skips the allocation of first memory blocks of which erase counts 704 exceed the dynamically adjusted first threshold value, among the memory blocks of the memory device 150, as target memory blocks for program operations. The controller 130 sequentially allocates second memory blocks of which erase counts 704 are equal to or less than the dynamically adjusted first threshold value, as target memory blocks for performing of program operations, through the round robin scheduling scheme. After allocating target memory blocks among the second memory blocks, the controller 130 performs program operations. The controller 130 allocates the first memory blocks of which erase counts 704 exceed the dynamically adjusted first threshold value, as target memory blocks for swap operations. The controller 130 performs swap operations, for example, a wear leveling operation, for the first memory blocks.

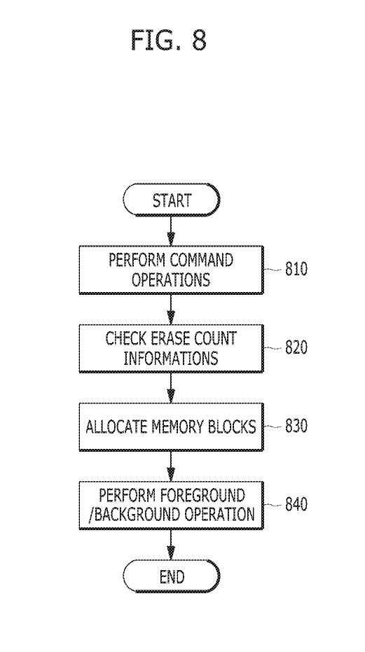

As is apparent from the above descriptions, in the memory system in accordance with the embodiment of the present disclosure, when performing command operations, e.g., program operations, in the memory blocks of the memory device 150, target memory blocks for performing of the command operations are allocated corresponding to the parameters after the controller 130 checks parameters for the respective memory blocks. Specifically, in the memory system in accordance with an embodiment of the present disclosure, when the controller 130 allocates target memory blocks in a round robin scheduling scheme, allocation of optional memory blocks as target memory blocks is skipped based on parameters. When command operations are performed for target memory blocks, a swap operation is performed for the skipped optional memory blocks. After dynamically allocating target memory blocks corresponding to not only the parameters but also the skipped optional memory blocks, the controller 130 performs the command operations. Hereinbelow, an operation for processing data in a memory system in accordance with an embodiment of the present disclosure will be described in detail with reference to FIG. 8.

FIG. 8 is an example of a schematic flow chart of an operation process for processing data in a memory system in accordance with an embodiment.

Referring to FIG. 8, at step 810, the memory system 110 performs command operations corresponding to the plurality of commands received from the host 102, in the memory blocks of the memory device 150.

At step 820, when performing the command operations, parameters for the respective memory blocks of the memory device 150 are checked. Particularly, erase counts corresponding to performing erase operations in the memory blocks are checked in the respective memory blocks.

At step 830, corresponding to the parameters for the respective memory blocks, target memory blocks for command operations such as program operations are allocated among the memory blocks. Specifically, corresponding to the erase counts for the respective memory blocks, target memory blocks for command operations are sequentially allocated among the memory blocks through a round robin scheduling scheme. When allocating target memory blocks, allocation of optional memory blocks as target memory blocks is skipped in correspondence to the erase counts. The skipped optional memory blocks are allocated as target memory blocks for swap operations.

At step 840, a foreground operation and a background operation are performed for the respective memory blocks of the memory device 150. Particularly, command operations as the foreground operation are performed in target memory blocks which are allocated for performing command operations. A swap operation as the background operation is performed in target memory blocks which are allocated for performing swap operations.

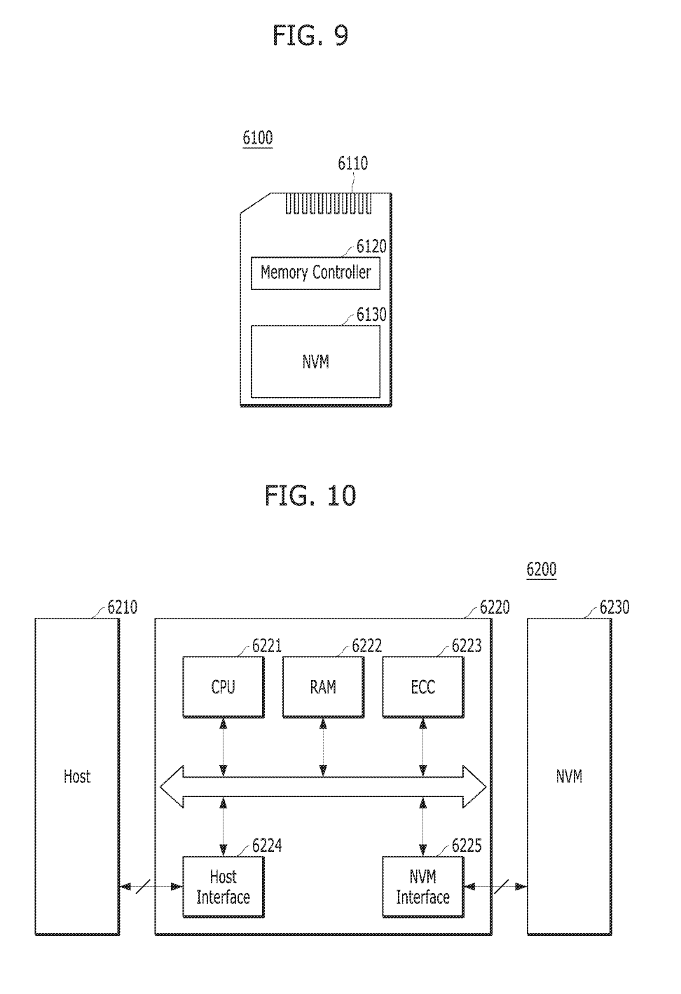

Since detailed descriptions were made above with reference to FIGS. 5 to 7 for checking of parameters, in particular, erase counts, for the respective memory blocks of the memory device 150, allocating target memory blocks for command operations, allocating target memory blocks for swap operations, corresponding to the erase counts, and performing the command operations and the swap operations in the target memory blocks, further descriptions thereof will be omitted herein. Hereinbelow, detailed descriptions will be made, with reference to FIGS. 9 to 17, for a data processing system and electronic appliances to which the memory system 110 including the memory device 150 and the controller 130, described above with reference to FIGS. 1 to 8, in accordance with the embodiment of the present disclosure, is applied.

FIGS. 9 to 17 are diagrams schematically illustrating application examples of the data processing system of FIG. 1.

FIG. 9 is a diagram schematically illustrating another example of the data processing system including the memory system in accordance with the present embodiment. FIG. 9 schematically illustrates a memory card system to which the memory system in accordance with the present embodiment is applied.

Referring to FIG. 9, the memory card system 6100 may include a memory controller 6120, a memory device 6130 and a connector 6110.

More specifically, the memory controller 6120 may be connected to the memory device 6130 embodied by a nonvolatile memory. The memory controller 6120 may be configured to access the memory device 6130. By way of example but not limitation, the memory controller 6120 may be configured to control read, write, erase and background operations of the memory device 6130. The memory controller 6120 may be configured to provide an interface between the memory device 6130 and a host, and to use a firmware for controlling the memory device 6130. That is, the memory controller 6120 may correspond to the controller 130 of the memory system 110 described with reference to FIGS. 1 and 7, and the memory device 6130 may correspond to the memory device 150 of the memory system 110 described with reference to FIGS. 1 and 7.

Thus, the memory controller 6120 may include a RAM, a processing unit, a host interface, a memory interface and an error correction unit. The memory controller 130 may further include the elements shown in FIG. 5.

The memory controller 6120 may communicate with an external device, for example, the host 102 of FIG. 1 through the connector 6110. For example, as described with reference to FIG. 1, the memory controller 6120 may be configured to communicate with an external device through one or more of various communication protocols such as universal serial bus (USB), multimedia card (MMC), embedded MMC (eMMC), peripheral component interconnection (PCI), PCI express (PCIe), Advanced Technology Attachment (ATA), Serial-ATA, Parallel-ATA, small computer system interface (SCSI), enhanced small disk interface (EDSI), Integrated Drive Electronics (IDE), Firewire, universal flash storage (UFS), WIFI and Bluetooth. Thus, the memory system and the data processing system in accordance with the present embodiment may be applied to wired/wireless electronic devices or particularly mobile electronic devices.

The memory device 6130 may be implemented by a nonvolatile memory. For example, the memory device 6130 may be implemented by various nonvolatile memory devices such as an erasable and programmable ROM (EPROM), an electrically erasable and programmable ROM (EEPROM), a NAND flash memory, a NOR flash memory, a phase-change RAM (PRAM), a resistive RAM (ReRAM), a ferroelectric RAM (FRAM) and a spin torque transfer magnetic RAM (S -RAM). The memory device 6130 may include a plurality of dies as in the memory device 150 of FIG. 5.

The memory controller 6120 and the memory device 6130 may be integrated into a single semiconductor device. For example, the memory controller 6120 and the memory device 6130 may construct a solid state driver (SSD) by being integrated into a single semiconductor device. Also, the memory controller 6120 and the memory device 6130 may construct a memory card such as a PC card (PCMCIA: Personal Computer Memory Card International Association), a compact flash (CF) card, a smart media card (e.g, SM and SMC), a memory stick, a multimedia card (e.g., MMC, RS-MMC, MMCmicro and eMMC), an SD card (e.g., SD, miniSD, microSD and SDHC) and a universal flash storage (UFS).

FIG. 10 is a diagram schematically illustrating another example of the data processing system including the memory system in accordance with the present embodiment.

Referring to FIG. 10, the data processing system 6200 may include a memory device 6230 having one or more nonvolatile memories and a memory controller 6220 for controlling the memory device 6230. The data processing system 6200 illustrated in FIG. 10 may serve as a storage medium such as a memory card (CF, SD, micro-SD or the like) or USB device, as described with reference to FIG. 1. The memory device 6230 may correspond to the memory device 150 in the memory system 110 illustrated in FIGS. 1 and 7. The memory controller 6220 may correspond to the controller 130 in the memory system 110 illustrated in FIGS. 1 and 7.

The memory controller 6220 may control a read, write or erase operation on the memory device 6230 in response to a request of the host 6210. The memory controller 6220 may include one or more CPUs 6221, a buffer memory such as RAM 6222, an ECC circuit 6223, a host interface 6224 and a memory interface such as an NVM interface 6225.

The CPU 6221 may control overall operations on the memory device 6230, for example, read, write, file system management and bad page management operations. The RAM 6222 may be operated according to control of the CPU 6221. The RAM 6222 may be used as a work memory, buffer memory or cache memory. When the RAM 6222 is used as a work memory, data processed by the CPU 6221 may be temporarily stored in the RAM 6222. When the RAM 6222 is used as a buffer memory, the RAM 6222 may be used for buffering data transmitted to the memory device 6230 from the host 6210 or transmitted to the host 6210 from the memory device 6230. When the RAM 6222 is used as a cache memory, the RAM 6222 may assist the low-speed memory device 6230 to operate at high speed.

The ECC circuit 6223 may correspond to the ECC unit 138 of the controller 130 illustrated in FIG. 1. As described with reference to FIG. 1, the ECC circuit 6223 may generate an ECC (Error Correction Code) for correcting a fail bit or error bit of data provided from the memory device 6230. The ECC circuit 6223 may perform error correction encoding on data provided to the memory device 6230, thereby forming data with a parity bit. The parity bit may be stored in the memory device 6230. The ECC circuit 6223 may perform error correction decoding on data outputted from the memory device 6230. At this time, the ECC circuit 6223 may correct an error using the parity bit. For example, as described with reference to FIG. 1, the ECC circuit 6223 may correct an error using the LDPC code, BCH code, turbo code, Reed-Solomon code, convolution code, RSC or coded modulation such as TCM or BCM.

The memory controller 6220 may transmit/receive data to/from the host 6210 through the host interface 6224. The memory controller 6220 may transmit/receive data to/from the memory device 6230 through the NVM interface 6225. The host interface 6224 may be connected to the host 6210 through a PATA bus, SATA bus, SCSI, USB, PCIe or NAND interface. The memory controller 6220 may have a wireless communication function with a mobile communication protocol such as WiFi or Long Term Evolution (LTE). The memory controller 6220 may be connected to an external device, for example, the host 6210 or another external device, and then transmit/receive data to/from the external device. As the memory controller 6220 is configured to communicate with the external device through one or more of various communication protocols, the memory system and the data processing system in accordance with the present embodiment may be applied to wired/wireless electronic devices or particularly a mobile electronic device.

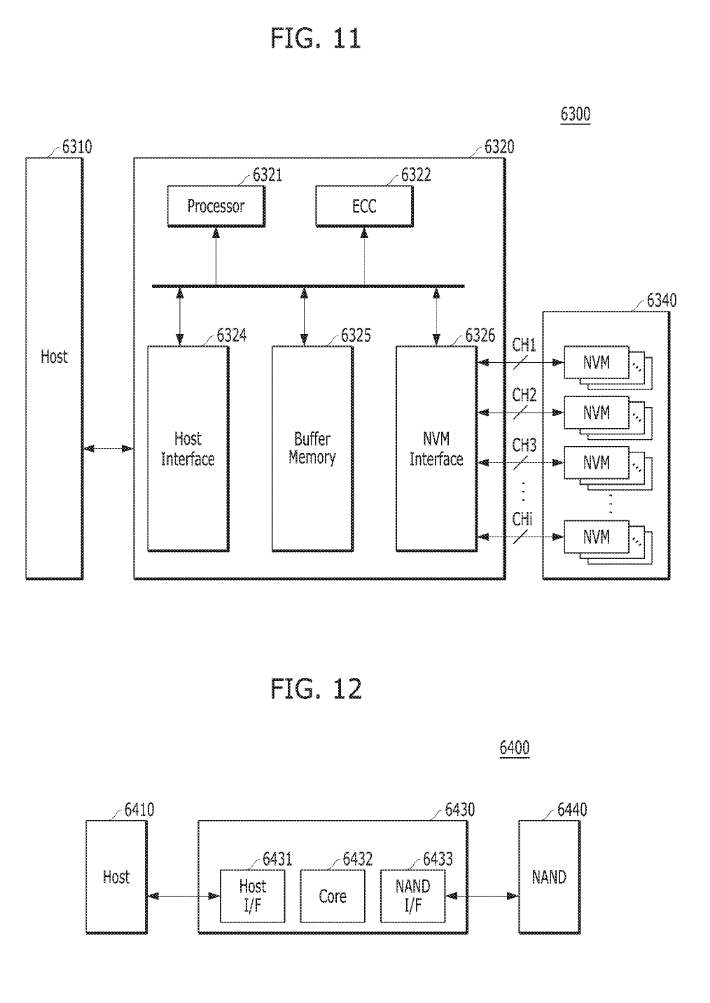

FIG. 11 is a diagram schematically illustrating another example of the data processing system including the memory system in accordance with the present embodiment. FIG. 11 schematically illustrates an SSD to which the memory system in accordance with the present embodiment is applied.

Referring to FIG. 11, the SSD 6300 may include a controller 6320 and a memory device 6340 including a plurality of nonvolatile memories. The controller 6320 may correspond to the controller 130 in the memory system 110 of FIGS. 1 and 7. The memory device 6340 may correspond to the memory device 150 in the memory system of FIGS. 1 and 7.

More specifically, the controller 6320 may be connected to the memory device 6340 through a plurality of channels CH1 to CHi. The controller 6320 may include one or more processors 6321, a buffer memory 6325, an ECC circuit 6322, a host interface 6324 and a memory interface, for example, a nonvolatile memory interface 6326.

The buffer memory 6325 may temporarily store data provided from the host 6310 or data provided from a plurality of flash memories NVM included in the memory device 6340, or temporarily store meta data of the plurality of flash memories NVM, for example, map data including a mapping table. The buffer memory 6325 may be embodied by volatile memories such as DRAM, SDRAM, DDR SDRAM, LPDDR SDRAM and GRAM or nonvolatile memories such as FRAM, ReRAM, STT-MRAM and PRAM. FIG. 10 illustrates that the buffer memory 6325 exists in the controller 6320, however, the buffer memory 6325 may exist outside the controller 6320.

The ECC circuit 6322 may calculate an ECC value of data to be programmed to the memory device 6340 during a program operation. The ECC circuit 6322 may perform an error correction operation on data read from the memory device 6340 based on the ECC value during a read operation. The ECC circuit 6322 may perform an error correction operation on data recovered from the memory device 6340 during a failed data recovery operation.

The host interface 6324 may provide an interface function with an external device, for example, the host 6310. The nonvolatile memory interface 6326 may provide an interface function with the memory device 6340 connected through the plurality of channels.

Furthermore, a plurality of SSDs 6300 to which the memory system 110 of FIGS. 1 and 7 is applied may be provided to embody a data processing system, for example, RAID (Redundant Array of Independent Disks) system. At this time, the RAID system may include the plurality of SSDs 6300 and a RAID controller for controlling the plurality of SSDs 6300. When the RAID controller performs a program operation in response to a write command provided from the host 6310, the RAID controller may select one or more memory systems or SSDs 6300 according to a plurality of RAID levels, that is, RAID level information of the write command provided from the host 6310 in the SSDs 6300. The RAID controller may output data corresponding to the write command to the selected SSDs 6300. Furthermore, when the RAID controller performs a read command in response to a read command provided from the host 6310, the RAID controller may select one or more memory systems or SSDs 6300 according to a plurality of RAID levels, that is, RAID level information of the read command provided from the host 6310 in the SSDs 6300. The RAID controller may provide data read from the selected SSDs 6300 to the host 6310.

FIG. 12 is a diagram schematically illustrating another example of the data processing system including the memory system in accordance with the present embodiment. FIG. 12 schematically illustrates an embedded Multi-Media Card (eMMC) to which the memory system in accordance with the present embodiment is applied.

Referring to FIG. 12, the eMMC 6400 may include a controller 6430 and a memory device 6440 embodied by one or more NAND flash memories. The controller 6430 may correspond to the controller 130 in the memory system 110 of FIGS. 1 and 7. The memory device 6440 may correspond to the memory device 150 in the memory system 110 of FIGS. 1 and 7.

More specifically, the controller 6430 may be connected to the memory device 6440 through a plurality of channels. The controller 6430 may include one or more cores 6432, a host interface 6431 and a memory interface, for example, a NAND interface 6433.

The core 6432 may control overall operations of the eMMC 6400. The host interface 6431 may provide an interface function between the controller 6430 and the host 6410. The NAND interface 6433 may provide an interface function between the memory device 6440 and the controller 6430. For example, the host interface 6431 may serve as a parallel interface, for example, MMC interface as described with reference to FIG. 1. Furthermore, the host interface 6431 may serve as a serial interface, for example, UHS ((Ultra High Speed)-I/UHS-II) interface.

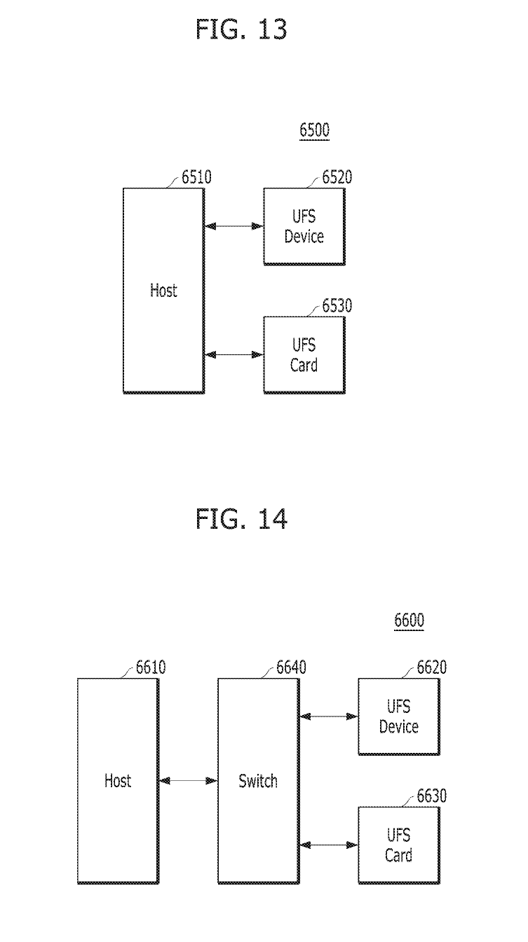

FIGS. 13 to 16 are diagrams schematically illustrating other examples of the data processing system including the memory system in accordance with the present embodiment. FIGS. 13 to 16 schematically illustrate UFS (Universal Flash Storage) systems to which the memory system in accordance with the present embodiment is applied.

Referring to FIGS. 13 to 16, the UFS systems 6500, 6600, 6700, 6800 may include hosts 6510, 6610, 6710, 6810, UFS devices 6520, 6620, 6720, 6820 and UFS cards 6530, 6630, 6730, 6830, respectively. The hosts 6510, 6610, 6710, 6810 may serve as application processors of wired/wireless electronic devices or particularly mobile electronic devices, the UFS devices 6520, 6620, 6720, 6820 may serve as embedded UFS devices, and the UFS cards 6530, 6630, 6730, 6830 may serve as external embedded UFS devices or removable UFS cards.

The hosts 6510, 6610, 6710, 6810, the UFS devices 6520, 6620, 6720, 6820 and the UFS cards 6530, 6630, 6730, 6830 in the respective UFS systems 6500, 6600, 6700, 6800 may communicate with external devices, for example, wired/wireless electronic devices or particularly mobile electronic devices through UFS protocols, and the UFS devices 6520, 6620, 6720, 6820 and the UFS cards 6530, 6630, 6730, 6830 may be embodied by the memory system 110 illustrated in FIGS. 1 and 7. For example, in the UFS systems 6500, 6600, 6700, 6800, the UFS devices 6520, 6620, 6720, 6820 may be embodied in the form of the data processing system 6200, the SSD 6300 or the eMMC 6400 described with reference to FIGS. 10 to 12, and the UFS cards 6530, 6630, 6730, 6830 may be embodied in the form of the memory card system 6100 described with reference to FIG. 9.

Furthermore, in the UFS systems 6500, 6600, 6700, 6800, the hosts 6510, 6610, 6710, 6810, the UFS devices 6520, 6620, 6720, 6820 and the UFS cards 6530, 6630, 6730, 6830 may communicate with each other through an UFS interface, for example, MIPI M-PHY and MIPI UniPro (Unified Protocol) in MIPI (Mobile Industry Processor Interface). Furthermore, the UFS devices 6520, 6620, 6720, 6820 and the UFS cards 6530, 6630, 6730, 6830 may communicate with each other through various protocols other than the UFS protocol, for example, UFDs, MMC, SD, mini-SD, and micro-SD.

In the UFS system 6500 illustrated in FIG. 13, each of the host 6510, the UFS device 6520 and the UFS card 6530 may include UniPro. The host 6510 may perform a switching operation to communicate with the UFS device 6520 and the UFS card 6530. The host 6510 may communicate with the UFS device 6520 or the UFS card 6530 through link layer switching, for example, L3 switching at the UniPro. At this time, the UFS device 6520 and the UFS card 6530 may communicate with each other through link layer switching at the UniPro of the host 6510. In the present embodiment, the configuration in which one UFS device 6520 and one UFS card 6530 are connected to the host 6510 has been exemplified for convenience of description. However, a plurality of UFS devices and UFS cards may be connected in parallel or in the form of a star to the host 6410. A plurality of UFS cards may be connected in parallel or in the form of a star to the UFS device 6520 or connected in series or in the form of a chain to the UFS device 6520.

In the UFS system 6600 illustrated in FIG. 14, each of the host 6610, the UFS device 6620 and the UFS card 6630 may include UniPro, and the host 6610 may communicate with the UFS device 6620 or the UFS card 6630 through a switching module 6640 performing a switching operation, for example, through the switching module 6640 which performs link layer switching at the UniPro, for example, L3 switching. The UFS device 6620 and the UFS card 6630 may communicate with each other through link layer switching of the switching module 6640 at UniPro. In the present embodiment, the configuration in which one UFS device 6620 and one UFS card 6630 are connected to the switching module 6640 has been exemplified for convenience of description. However, a plurality of UFS devices and UFS cards may be connected in parallel or in the form of a star to the switching module 6640. A plurality of UFS cards may be connected in series or in the form of a chain to the UFS device 6620.

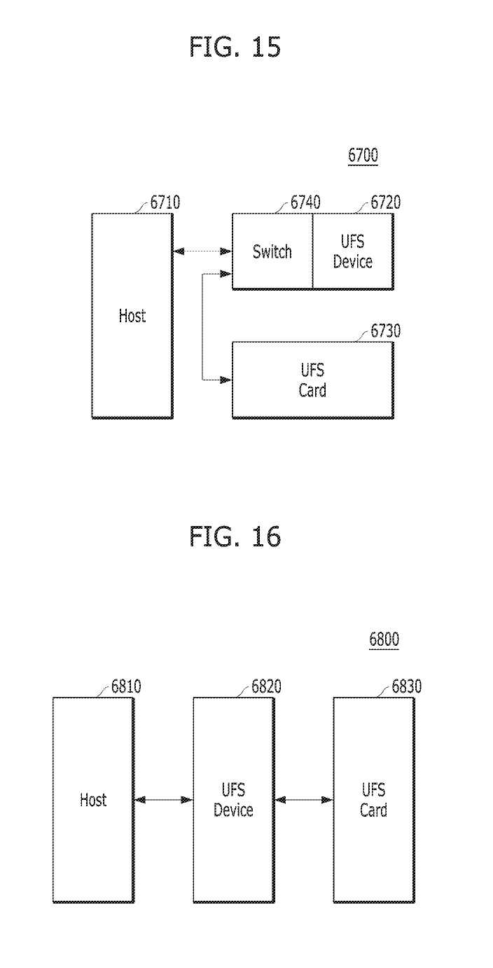

In the UFS system 6700 illustrated in FIG. 15, each of the host 6710, the UFS device 6720 and the UFS card 6730 may include UniPro. The host 6710 may communicate with the UFS device 6720 or the UFS card 6730 through a switching module 6740 performing a switching operation, for example, through the switching module 6740 which performs link layer switching at the UniPro, for example, L3 switching. At this time, the UFS device 6720 and the UFS card 6730 may communicate with each other through link layer switching of the switching module 6740 at the UniPro, and the switching module 6740 may be integrated as one module with the UFS device 6720 inside or outside the UFS device 6720. In the present embodiment, the configuration in which one UFS device 6720 and one UFS card 6730 are connected to the switching module 6740 has been exemplified for convenience of description. However, a plurality of modules, each including the switching module 6740 and the UFS device 6720, may be connected in parallel or in the form of a star to the host 6710 or connected in series or in the form of a chain to each other. Furthermore, a plurality of UFS cards may be connected in parallel or in the form of a star to the UFS device 6720.

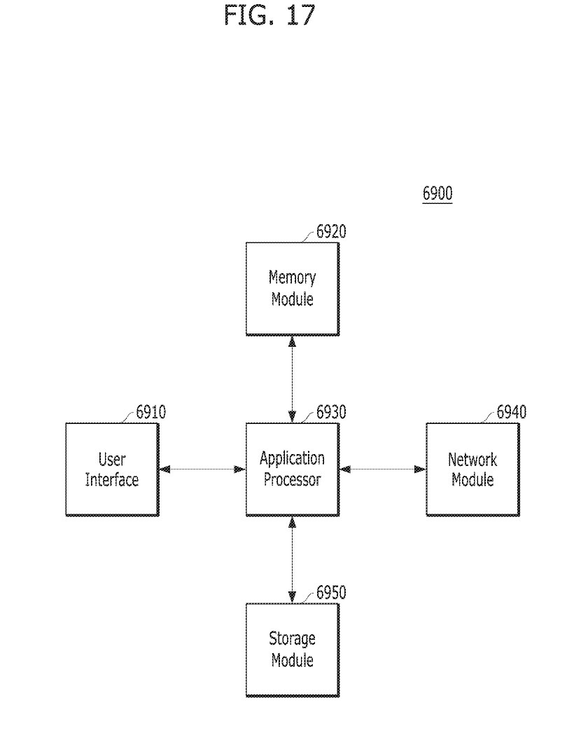

In the UFS system 6800 illustrated in FIG. 16, each of the host 6810, the UFS device 6820 and the UFS card 6830 may include M-PHY and UniPro. The UFS device 6820 may perform a switching operation to communicate with the host 6810 and the UFS card 6830. In particular, the UFS device 6820 may communicate with the host 6810 or the UFS card 6830 through a switching operation between the M-PHY and UniPro module for communication with the host 6810 and the M-PHY and UniPro module for communication with the UFS card 6830, e.g., through a target ID (Identifier) switching operation. At this time, the host 6810 and the UFS card 6830 may communicate with each other through target ID switching between the M-PHY and UniPro modules of the UFS device 6820. In the present embodiment, the configuration in which one UFS device 6820 is connected to the host 6810 and one UFS card 6830 is connected to the UFS device 6820 has been exemplified for convenience of description. However, a plurality of UFS devices may be connected in parallel or in the form of a star to the host 6810. The form of a star is an arrangement in which has a centralized portion having a single component and plural devices connected to the centralized portion. Otherwise, a plurality of UFS devices may be connected in series or in the form of a chain to the host 6810. A plurality of UFS cards may be connected in parallel or in the form of a star to the UFS device 6820, or connected in series or in the form of a chain to the UFS device 6820.

FIG. 17 is a diagram schematically illustrating another example of the data processing system including the memory system in accordance with an embodiment. FIG. 17 is a diagram schematically illustrating a user system to which the memory system in accordance with the present embodiment is applied.

Referring to FIG. 17, the user system 6900 may include an application processor 6930, a memory module 6920, a network module 6940, a storage module 6950 and a user interface 6910.

More specifically, the application processor 6930 may drive components included in the user system 6900, for example, an OS, and include controllers, interfaces and a graphic engine which control the components included in the user system 6900. The application processor 6930 may be provided as a System-on-Chip (SoC).

The memory module 6920 may be used as a main memory, work memory, buffer memory or cache memory of the user system 6900. The memory module 6920 may include a volatile RAM such as DRAM, SDRAM, DDR SDRAM, DDR2 SDRAM, DDR3 SDRAM, LPDDR SDARM, LPDDR3 SDRAM or LPDDR3 SDRAM or a nonvolatile RAM such as PRAM, ReRAM, MRAM or FRAM. By way of example but not limitation, the application processor 6930 and the memory module 6920 may be packaged and mounted, based on POP (Package on Package).

The network module 6940 may communicate with external devices. By way of example but not limitation, the network module 6940 may not only support wired communication, but also support various wireless communication protocols such as code division multiple access (CDMA), global system for mobile communication (GSM), wideband CDMA (WCDMA), CDMA-2000, time division multiple access (TDMA), long term evolution (LTE), worldwide interoperability for microwave access (Wimax), wireless local area network (WLAN), ultra-wideband (UWB), Bluetooth, wireless display (WI-DI), thereby communicating with wired/wireless electronic devices or particularly mobile electronic devices. Therefore, the memory system and the data processing system, in accordance with an embodiment of the present invention, can be applied to wired/wireless electronic devices. The network module 6940 may be included in the application processor 6930.

The storage module 6950 may store data, for example, data received from the application processor 6930. The storage module 6950 may transmit the stored data to the application processor 6930. The storage module 6950 may be embodied by a nonvolatile semiconductor memory device such as a phase-change RAM (PRAM), a magnetic RAM (MRAM), a resistive RAM (ReRAM), a NAND flash, a NOR flash and a 3D NAND flash, and provided as a removable storage medium such as a memory card or an external drive of the user system 6900. The storage module 6950 may correspond to the memory system 110 described with reference to FIGS. 1 and 7. Furthermore, the storage module 6950 may be embodied as an SSD, an eMMC and an UFS as described above with reference to FIGS. 11 to 16.

The user interface 6910 may include interfaces for inputting data or commands to the application processor 6930 or outputting data to an external device. By way of example but not limitation, the user interface 6910 may include user input interfaces such as a keyboard, a keypad, a button, a touch panel, a touch screen, a touch pad, a touch ball, a camera, a microphone, a gyroscope sensor, a vibration sensor and a piezoelectric element, and user output interfaces such as a liquid crystal display (LCD), an organic light emitting diode (OLED) display device, an active matrix OLED (AMOLED) display device, an LED, a speaker and a motor.

Furthermore, when the memory system 110 of FIGS. 1 and 7 is applied to a mobile electronic device of the user system 6900, the application processor 6930 may control overall operations of the mobile electronic device, and the network module 6940 may serve as a communication module for controlling wired/wireless communication with an external device. The user interface 6910 may display data processed by the processor 6930 on a display/touch module of the mobile electronic device. The user interface 6910 may support a function of receiving data from the touch panel.

The memory system and the operating method thereof according to the embodiments may minimize complexity and performance deterioration of the memory system and maximize use efficiency of a memory device, thereby quickly and stably process data with respect to the memory device.

Although various embodiments have been described for illustrative purposes, it will be apparent to those skilled in the art that various changes and modifications may be made without departing from the spirit and scope of the invention as defined in the following claims.

What is claimed is:

1. A memory system comprising:
a memory device including a plurality of pages in which data are stored and a plurality of memory blocks in which the pages are included; and
a controller suitable for performing command operations corresponding to a plurality of commands received from a host, in the memory blocks, checking parameters for the memory blocks corresponding to performing the command operations, and allocating second memory blocks as first target memory blocks based on the parameters after skipping the first memory blocks among the memory blocks.

2. The memory system according to claim 1, wherein the controller sequentially allocates the second memory blocks among the memory blocks, as the first target memory blocks, through a round robin scheduling scheme.

3. The memory system according to claim 1, wherein the controller allocates the second memory blocks as the first target memory blocks for performing command operations, and allocates the first memory blocks as second target memory blocks for performing a swap operation.

4. The memory system according to claim 3,
wherein parameters for the first memory blocks exceed a first threshold value, and
wherein parameters for the second memory blocks are equal to or less than the first threshold value.

5. The memory system according to claim 4, wherein the controller determines the first threshold value corresponding to the parameters, and calculates a threshold offset corresponding to the number of the first memory blocks and the parameters of the first memory blocks.

6. The memory system according to claim 5,
wherein the controller dynamically adjusts the first threshold value corresponding to the threshold offset, and
wherein the number of the first memory blocks and the number of the second memory blocks among the memory blocks are adjusted depending on the first threshold value which is adjusted dynamically.

7. The memory system according to claim 6, wherein the controller counts the number of the first memory blocks, and calculates the threshold offset when the number of the first memory blocks exceeds a second threshold value.

8. The memory system according to claim 7, wherein the controller determines the second threshold value corresponding to the number of the second memory blocks and the number of the second target memory blocks.

9. The memory system according to claim 8,
wherein the controller determines, as the first threshold value, at least one among an average value, a calculation value of a maximum value and a minimum value and a metric calculation value for the parameters, and determines, as the second threshold value, at least one among an average value, a minimum value and a metric calculation value for the number of the second memory blocks and the number of the second target memory blocks,
wherein the controller calculates, as the threshold offset, at least one among an offset between an average value for the first memory blocks and the first threshold value, an offset between a calculation value of a maximum value, a minimum value and the first threshold value, and an offset between a metric calculation value and the first threshold value.

10. The memory system according to claim 7, wherein the controller adjusts a triggering rate of the swap operation corresponding to the number of the first memory blocks.

11. A method for operating a memory system, comprising:
receiving a plurality of commands from a host, for a memory device including a plurality of pages in which data are stored and a plurality of memory blocks in which the pages are included;
performing command operations corresponding to the commands, in the memory blocks;
checking parameters for the memory blocks corresponding to performing the command operations; and
allocating second memory blocks as first target memory blocks based on the parameters after skipping first memory blocks among the memory blocks.

12. The method according to claim 11, wherein the allocating sequentially allocates the second memory blocks among the memory blocks, as the first target memory blocks, through a round robin scheduling scheme.

13. The method according to claim 11, wherein the allocating comprises:
allocating the second memory blocks as the first target memory blocks for performing command operations; and
allocating the first memory blocks as second target memory blocks for performing a swap operation.

14. The method according to claim 13,
wherein parameters for the first memory blocks exceed a first threshold value, and
wherein parameters for the second memory blocks are equal to or less than the first threshold value.

15. The method according to claim 14, further comprising::
determining the first threshold value corresponding to the parameters;
determining a second threshold value corresponding to the number of the second memory blocks and the number of the second target memory blocks;
calculating a threshold offset corresponding to the number of the first memory blocks and parameters of the first memory blocks;
dynamically adjusting the first threshold value corresponding to the threshold offset; and
adjusting a triggering rate of the swap operation corresponding to the number of the first memory blocks.

16. The method according to claim 15, wherein the number of the first memory blocks and the number of the second memory blocks among the memory blocks are adjusted depending on the first threshold value which is adjusted dynamically.

17. The method according to claim 16, wherein the calculating comprises:
counting the number of the first memory blocks; and
calculating the threshold offset when the number of the first memory blocks exceeds the second threshold value.

18. The method according to claim 17, wherein the calculating calculates, as the threshold offset, at least one among an offset between an average value for the first memory blocks and the first threshold value, an offset between a calculation value of a maximum value, a minimum value and the first threshold value, and an offset between a metric calculation value and the first threshold value.

19. The method according to claim 15, p1 wherein the determining of the first threshold value determines, as the first threshold value, at least one among an average value, a calculation value of a maximum value, a minimum value and a metric calculation value for the parameters, and
wherein the determining of the second threshold value determines, as the second threshold value, at least one among an average value, a minimum value and a metric calculation value for the number of the second memory blocks and the number of the second target memory blocks.

20. A memory system comprising:
a memory device including a plurality of memory blocks, each including a plurality of pages; and
a controller suitable for allocating at least one memory block to a first operation in response to a command delivered from a host, checking parameters for allocated memory block, and re-allocating the allocated memory block based on the parameters to a second operation,
wherein the first operation is performed in response to the command, while the second operation is a background operation.
